(19) United States
(12) Patent Application Publication
(10) Pub. No.: US 2023/0131597 A1
(43) Pub. Date: Apr. 27, 2023

(54) DIRT REPELLING CLEANING COMPOSITIONS AND METHODS OF USE THEREOF

(71) Applicant: Energizer Auto, Inc., St. Louis, MO (US)

(72) Inventors: Rajeev Memon, Dayton, OH (US); Hirotaka Uchiyama, Loveland, OH (US)

(21) Appl. No.: 17/915,854

(22) PCT Filed: Apr. 1, 2021
(86) PCT No.: PCT/US21/25401

§ 371 Date: Sep. 29, 2022

Related U.S. Application Data
(60) Provisional application No. 63/003,418, filed on Apr. 1, 2020.

(51) Int. Cl. C11D 7/32; C11D 7/12; C11D 7/50; C11D 11/00; C11D 17/00

(52) U.S. Cl. CPC C11D 7/3209; C11D 7/12; C11D 7/5022; C11D 11/0041; C11D 17/0017; B60S 3/045

(57) ABSTRACT

Described herein are compositions and methods for use in automotive care. The present disclosure includes compositions directed to, for example, a wheel cleaner.

### CROSS-REFERENCE TO RELATED APPLICATIONS

This application claims priority to U.S. Provisional Application Ser. No. 63/003,418, filed on Apr. 1, 2020, the content of which is hereby incorporated by reference in its entirety.

### FIELD OF THE DISCLOSURE

Described herein are compositions and methods for use in automotive care. The present disclosure includes compositions directed to, for example, a wheel cleaner.

### BACKGROUND OF THE DISCLOSURE

Wheel cleaning products in the automotive industry use standard ingredients for cleaning. As one example, wheel cleaning products in the automotive industry use alkaline or acidifying agents in combination with surfactants (anionic, non-ionic and amphoteric), glycol ethers and chelating agents. These products however have room for improvement.

There is a need for cleaning compositions that can not only help provide cleaning but at the same time provide long term cleaning benefits by providing hydrophobicity to the surface, thereby repelling water borne dirt. There is a need, therefore, for improved cleaning compositions in the wheel cleaning sector of the automotive industry.

### SUMMARY OF THE DISCLOSURE

In one aspect, the present disclosure is directed to a composition comprising: an amino functional silicone emulsion, a first alkaline agent, and, a second alkaline agent.

In another aspect, the present disclosure is directed to method of treating an automotive surface, the method comprising: applying a composition to an automotive surface, wherein the composition comprises: an amino functional silicone emulsion; a first alkaline agent; and, a second alkaline agent.

### BRIEF DESCRIPTION OF THE DRAWINGS

FIG. 1A depicts a dirty wheel.

FIG. 1B depicts a dirty wheel, where half of the wheel has been treated with a wheel cleaning composition in accordance with the present disclosure and let to sit for 3 minutes. The wheel was then scrubbed with a brush.

FIG. 1C depicts a wheel, where half of the wheel has been treated with a wheel cleaning composition in accordance with the present disclosure, being sprayed with water.

FIG. 1D depicts dirty muddy water being thrown at a wheel that has been treated with a wheel cleaning composition in accordance with the present disclosure.

FIG. 1E depicts the repellency of dirty water from a portion of a wheel that has been treated with a wheel cleaning composition in accordance with the present disclosure, while the untreated side is covered in dirty water.

FIG. 2A depicts a dirtied aluminum panel.

FIG. 2B depicts a dirtied aluminum panel sprayed with water. The panel is not cleaned by the water.

FIG. 2C depicts a dirtied aluminum panel, where the panel has been treated with a wheel cleaning composition in accordance with the present disclosure and let to sit for 3-5 minutes.

FIG. 2D depicts a dirtied aluminum panel, where the panel has been treated with a wheel cleaning composition in accordance with the present disclosure and let to sit for 3-5 minutes, after being sprayed down with water. The panel is cleaned.

### DETAILED DESCRIPTION OF THE DISCLOSURE

Described herein are compositions and methods for cleaning wheels of an automotive device.

The present disclosure is directed to a wheel cleaning composition for an automotive device (car, truck, motorcycle, etc.). In some embodiments, the composition is sprayed onto a dirty wheel and left to sit for 2 minutes and rinsed off with water to remove dirt. This is followed up with spraying the composition again to impart the amino functional silicone component to the wheel, which will impart hydrophobicity or water repellency.

In some embodiments, the composition comprises an amino functional silicone emulsion; a first alkaline agent; and, a second alkaline agent.

In some embodiments, a method of treating an automotive surface using the composition is disclosed. The method comprises: applying a composition to an automotive surface, wherein the composition comprises: an amino functional silicone emulsion; a first alkaline agent; and, a second alkaline agent.

In some embodiments, the amino functional silicone emulsion comprises an aminoalkyl-functional organopolysiloxane fluid and water. In some embodiments, the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof.

In some embodiments, the amino functional silicone emulsion comprises from about 30% to about 40% of an amino silicone polymer, from about 5% to about 15% glycerol, from about 10% to about 20% of an alcohol ethoxylate (e.g., tridecanol ethoxylate) and from about 35% to about 45% water, by weight of the emulsion. In some embodiments, the amino functional silicone emulsion comprises from about 50% to about 70% water, less than about 1.0% of a pH adjuster (e.g., acetic acid), less than about 0.5% of a viscosity adjuster (e.g., sodium chloride), from about 10% to about 15% of an emulsifier, and from about 20% to about 35% of an amino silicone polymer, by weight of the emulsion. In some embodiments, the amino functional silicone emulsion is selected from the group consisting of Elkay LK Primasoft Power and Siltech E-4135. In some embodiments, the amino functional silicone emulsion is selected from the group consisting of Elkay LK Primasoft Power and Siltech E-4135.

In some embodiments, the amino functional silicone emulsion is soluble in water.

In some embodiments, the amino functional silicone emulsion has a pH of from about 3 to about 6. In some embodiments, the amino functional silicone emulsion starts to destabilize at higher pH, such as a range of 10 and above, and/or by using strong alkaline agents.

In some embodiments, the amino functional silicone emulsion is present in an amount of from about 0.5% to about 20%, from about 3% to about 15%, from about 5% to about 10%, or about 9.5% by weight of the composition.

In some embodiments, the first alkaline agent is present in an amount of from about 0.01% to about 1.5%, from about 0.05% to about 1.2%, from about 0.7% to about 1.0%, or about 0.95% by weight of the composition. In some embodiments, the first alkaline agent is sodium carbonate.

In some embodiments, the second alkaline agent is present in an amount of from about 0.01% to about 1.5%, from about 0.05% to about 1.2%, from about 0.7% to about 1.0%, or about 0.95% by weight of the composition. In some embodiments, the second alkaline agent is sodium bicarbonate.

In some embodiments, the composition further comprises a preservative. In some embodiments, the preservative is present in an amount of from about 0.01% to about 0.1%, by weight of the composition. In some embodiments, the preservative is Troyguard BC11.

In some embodiments, the composition further comprises a propellant. In some embodiments, the propellant is present in an amount of from about 0.5% to about 15%, from about 2% to about 10%, from about 3 to about 7%, or about 5%, by weight of the composition. In some embodiments, the propellant is A-70 propellant.

In some embodiments, the composition further comprises water. In some embodiments, the water is present in an amount of from about 70% to about 95% from about 75% to about 90%, from about 80% to 85%, or about 83.5% by weight of the composition.

In some embodiments, the composition further comprises one or more solvents. In some embodiments, the composition comprises a first solvent and a second solvent.

In some embodiments, the first solvent is present in an amount of from about 0.1% to about 10%, from about 0.5% to about 7%, from about 3% to about 5%, or about 2.8% by weight of the composition. In some embodiments, the first solvent is an alcohol. In some embodiments, the first solvent is isopropyl alcohol.

In some embodiments, the second solvent is present in an amount of from about 0.1% to about 10%, from about 0.5% to about 7%, from about 3% to about 5%, or about 2.8% by weight of the composition. In some embodiments, the second solvent is a glycol ether. In some embodiments, the second solvent is butyl carbitol.

In some embodiments, the composition is free of any surfactants. In some embodiments, the composition is free of silicone oil.

In some embodiments, the composition is applied to an automotive surface. In some embodiments, the automotive surface is selected from the group consisting of a tire, wheel, paint, hood, roof, trunk, an exterior part, an interior part, and combinations thereof. In some embodiments, the automotive surface is a wheel.

This composition is intended to provide cleaning of the wheel and impart hydrophobicity so that dirt is repelled in the future when the car is driven. The critical component comprises an amino functional siloxane emulsion (e.g., Siltech E-4135, LK-Primasoft Power, etc.). Usually, wheel cleaners are alkaline in nature as alkalinity helps remove road grime and dirt effectively. The pH of most alkaline cleaners is above 10 and in the range of about 12 to 14. The pH of a typical alkaline cleaner is about 12.5.

Amino functional siloxane emulsions are generally stable in acidic to slightly neutral conditions of pH 3-7.5. At anything above this pH, the ability of the amino siloxane to impart hydrophobicity is drastically reduced. In some embodiments, sodium carbonate and sodium bicarbonate are present in the composition at a 1:1 ratio, which buffers the system to a pH of 9.2-9.8. For example, for any given amount of Siltech E-4135 added to water, 2 wt. % of sodium carbonate and 2 wt. % sodium bicarbonate are added and the pH will still remain 9.2-9.8. In some embodiments, the pH is about 9.6.

Preferably, the alkaline agents are weak alkaline agents. Examples include sodium carbonate, sodium bicarbonate, sodium citrate, and combinations thereof. In some embodiments, weak alkaline agents maximize the efficacy of cleaning. In addition, in some embodiments, weak alkaline agents improve logistics by allowing higher manufacturing and processing tolerances. In some embodiments, the first alkaline agent and the second alkaline agent are each weak alkaline agents.

In some embodiments, the composition does not comprise a strong alkaline agent. Strong alkaline agents, such as sodium hydroxide and potassium hydroxide, quickly destabilize the amino functional silicone emulsion. In addition, strong alkaline agents do not provide logistic benefits of higher manufacturing and processing tolerances. Strong alkaline agents also increase the pH drastically at very small incremental change to the wt. %, which may destabilize the amino functional silicone emulsion.

At this pH range, the alkaline agents provide an amount of cleaning activity, although less cleaning activity than a highly alkaline formula with a pH of 11-14, and the amino functional silicone emulsion provides an amount of water repellency. In some embodiments, when the amino functional silicone emulsion contains non-ionic surfactants (such as Siltech E-4135), the formula provides cleaning (through emulsification) and foaming (which provides cling to the wheels).

Compositions in accordance with the present disclosure are generally intended for lightly soiled wheels and cannot be classified as a heavy duty wheel cleaner.

In some embodiments, the composition comprises the following formulation:

| Ingredient | Wt. % in form | Wt. % in conc. | Purpose |
|---|---|---|---|
| DI Water | 83.55250% | 87.950% | Aqua |
| Siltech E-4135 | 9.50000% | 10.000% | Amino Silicone |
| Sodium Carbonate | 0.95000% | 1.000% | Cleaning agent, |
| | | | alkaline agent |
| Sodium Bicarbonate | 0.95000% | 1.000% | Cleaning agent, |
| | | | alkaline agent |
| Troyguard BC11 | 0.04750% | 0.050% | Preservative |
| Total Concentrate | 95% | 100% | |
| A-70 Propellant | 5% | | Propellant |

In some embodiments of the present disclosure, the composition is a fluid, such as a liquid. In some embodiments, the composition is a liquid and is applied by the means of aerosol, trigger sprayers, sponge, and combinations thereof.

The embodiments of this disclosure include:

1. A composition comprising:

an amino functional silicone emulsion;

a first alkaline agent; and,

a second alkaline agent.

2. The composition of embodiment 1, wherein the amino functional silicone emulsion comprises an aminoalkyl-functional organopolysiloxane fluid and water.

3. The composition of embodiment 2, wherein the aminoalkyl-functional organopolysiloxane fluid is selected from the group consisting of an amine-alkyl/dimethyl copolymer, a polar amine/alkyl functional block, an amine/alkoxy end-blocked silicone, and combinations thereof.

4. The composition of embodiment 1, wherein the amino functional silicone emulsion is selected from the group consisting of Elkay LK Primasoft Power and Siltech E-4135.

5. The composition of embodiment 1, wherein the amino functional silicone emulsion is soluble in water.

6. The composition of embodiment 1, wherein the amino functional silicone emulsion has a pH of from about 3 to about 6.

7. The composition of embodiment 1, wherein the amino functional silicone emulsion is present in an amount of from about 0.5% to about 20%, from about 3% to about 15%, from about 5% to about 10%, or about 9.5% by weight of the composition.

8. The composition of embodiment 1, wherein the first alkaline agent is present in an amount of from about 0.01% to about 1.5%, from about 0.05% to about 1.2%, from about 0.7% to about 1.0%, or about 0.95% by weight of the composition.

9. The composition of embodiment 1, wherein the first alkaline agent is sodium carbonate.

10. The composition of embodiment 1, wherein the second alkaline agent is present in an amount of from about 0.01% to about 1.5%, from about 0.05% to about 1.2%, from about 0.7% to about 1.0%, or about 0.95% by weight of the composition.

11. The composition of embodiment 1, wherein the second alkaline agent is sodium bicarbonate.

12. The composition of embodiment 1, further comprising a preservative.

13. The composition of embodiment 12, wherein the preservative is present in an amount of from about 0.01% to about 0.1%, by weight of the composition.

14. The composition of embodiment 12, wherein the preservative is Troyguard BC11.

15. The composition of embodiment 1, further comprising a propellant.

16. The composition of embodiment 15, wherein the propellant is present in an amount of from about 0.5% to about 15%, from about 2% to about 10%, from about 3 to about 7%, or about 5%, by weight of the composition.

17. The composition of embodiment 15, wherein the propellant is A-70 propellant.

18. The composition of embodiment 1, further comprising water.

19. The composition of embodiment 18, wherein the water is present in an amount of from about 70% to about 95% from about 75% to about 90%, from about 80% to 85%, or about 83.5% by weight of the composition.

20. The composition of embodiment 1, further comprising one or more solvents.

21. The composition of embodiment 1, further comprising a first solvent and a second solvent.

22. The composition of embodiment 21, wherein the first solvent is present in an amount of from about 0.1% to about 10%, from about 0.5% to about 7%, from about 3% to about 5%, or about 2.8% by weight of the composition.

23. The composition of embodiment 21, wherein the first solvent is isopropyl alcohol.

24. The composition of embodiment 21, wherein the second solvent is present in an amount of from about 0.1% to about 10%, from about 0.5% to about 7%, from about 3% to about 5%, or about 2.8% by weight of the composition.

25. The composition of embodiment 21, wherein the second solvent is butyl carbitol.

26. The composition of embodiment 1, wherein the composition is applied to an automotive surface.

27. The composition of embodiment 26, wherein the automotive surface is selected from the group consisting of a tire, wheel, paint, hood, roof, trunk, an exterior part, an interior part, and combinations thereof.

28. The composition of embodiment 26, wherein the automotive surface is a wheel.

29. The composition of embodiment 1, wherein the composition is a fluid, such as a liquid, and the liquid is applied by the means of an aerosol, a trigger sprayer, a sponge, and combinations thereof.

30. The composition of embodiment 1, wherein the composition is free of any surfactants.

31. The composition of embodiment 1, wherein the composition is free of silicone oil.

32. The composition of embodiment 1, wherein the first alkaline agent and the second alkaline agent are each weak alkaline agents.

33. The composition of embodiment 1, wherein the composition has a pH in the range of from about 9.2 to about 9.8.

34. A method of treating an automotive surface, the method comprising:

applying a composition to an automotive surface, wherein the composition comprises:

an amino functional silicone emulsion;

a first alkaline agent; and,

a second alkaline agent.

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever.

### Example 1

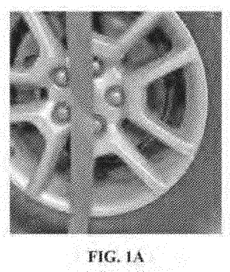

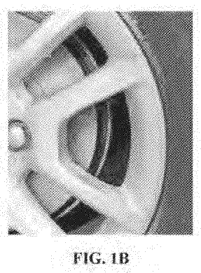

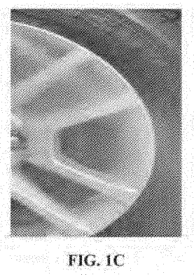

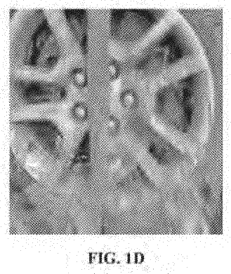

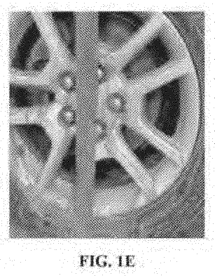

The cleaning capabilities and the dirt repellency of the wheel cleaning composition in accordance with the present disclosure is shown in FIGS. 1A-1E. FIG. 1A depicts a dirty wheel. Half of the wheel is treated with the wheel cleaning composition, let to sit for 3 minutes, and scrubbed with a brush in FIG. 1B. The wheel is sprayed with water in FIG. 1C.

After spraying with water, the tire is dirtied by throwing dirty muddy water at it in FIG. 1D. As can be seen in FIG. 1E, the half of the wheel treated with the wheel cleaning composition repels dirty water while the untreated half of the wheel is covered in dirty water.

### Example 2

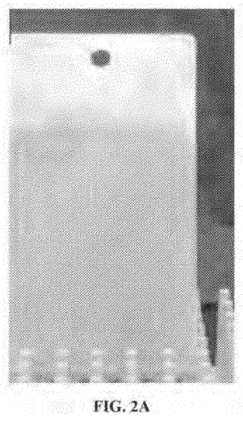

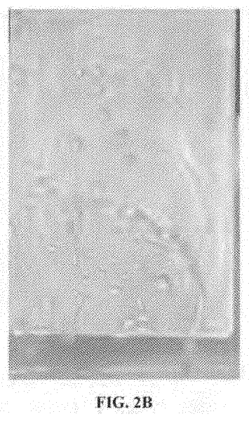

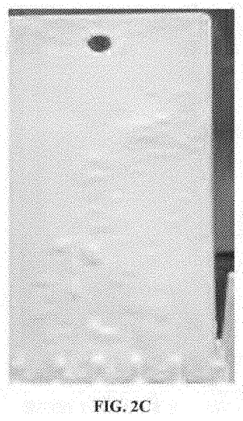

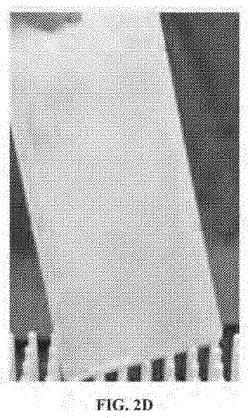

The cleaning capabilities and the dirt repellency of the wheel cleaning composition in accordance with the present disclosure is shown in FIGS. 2A-2D.

FIG. 2A depicts a dirtied aluminum panel. The dirtied aluminum panel is sprayed with water in FIG. 2B, but it is not cleaned by the water.

FIG. 2C depicts a dirtied aluminum panel, where the panel has been treated with a wheel cleaning composition in accordance with the present disclosure and let to sit for 3-5 minutes.

FIG. 2D depicts a dirtied aluminum panel, where the panel has been treated with a wheel cleaning composition in accordance with the present disclosure and let to sit for 3-5 minutes, after being sprayed down with water. The panel is cleaned.

The composition applied to the dirtied panel is listed below. This composition provides a mixture of different types of soiling that a wheel could experience.

| Ingredient | Wt. % |
|---|---|
| Lithium grease | 13.9 |
| Black charm clay | 27.8 |
| Dirty motor oil (used motor oil) | 11.11 |
| Brake dust | 5.5 |
| Odorless mineral spirits | 41.69 |

### Example 3

The cleaning capabilities and the dirt repellency of the wheel cleaning composition in accordance with the present disclosure is shown in FIGS. 2A-2D.

Contact angle was measured on a metal surface. The metal was the same as metals used for making car bodies (e.g. aluminum). A flat piece of this metal was chosen instead of measurement on wheels because typical wheel surfaces are curved and making consistent measurements is difficult.

Contact angle was measured before and after treatment using a mobile surface analyzer instrument. Higher contact angle indicates higher hydrophobicity or more water beading.

| Sample | Contact Angle (degrees) |
|---|---|
| Metal panel before treatment | 79.46 +/− 2.3 |
| Metal panel after treatment | 94.89 +/− 4.7 |

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure.

The term “consisting essentially of” occupies a middle ground between “comprising” and “consisting of”.

Where a disclosure or a portion thereof is defined with an open-ended term such as “comprising,” it should be readily understood that (unless otherwise stated) the description should be interpreted to also describe such a disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. A composition comprising:
an amino functional silicone emulsion;
a first alkaline agent; and,
a second alkaline agent.

2. The composition of claim 1, wherein the amino functional silicone emulsion comprises an aminoalkyl-functional organopolysiloxane fluid and water.

3. The composition of claim 1, wherein the amino functional silicone emulsion has a pH of from about 3 to about 6.

4. The composition of claim 1, wherein the amino functional silicone emulsion is present in an amount of from about 0.5% to about 20% by weight of the composition.

5. The composition of claim 1, wherein the first alkaline agent is present in an amount of from about 0.01% to about 1.5% by weight of the composition.

6. The composition of claim 1, wherein the second alkaline agent is present in an amount of from about 0.01% to about 1.5% by weight of the composition.

7. The composition of claim 1, further comprising a component selected from the group consisting of a preservative, a propellant, water, and combinations thereof.

8. The composition of claim 1, further comprising one or more solvents.

9. The composition of claim 1, further comprising a first solvent and a second solvent.

10. The composition of claim 9, wherein the first solvent is present in an amount of from about 0.1% to about 10% by weight of the composition.

11. The composition of claim 9, wherein the first solvent is isopropyl alcohol.

12. The composition of claim 9, wherein the second solvent is present in an amount of from about 0.1% to about 10% by weight of the composition.

13. The composition of claim 9, wherein the second solvent is butyl carbitol.

14. The composition of claim 1, wherein the composition is free of a component selected from the group consisting of surfactants, silicone oil, and combinations thereof.

15. The composition of claim 1, wherein the first alkaline agent and the second alkaline agent are each weak alkaline agents.

16. The composition of claim 1, wherein the composition has a pH in the range of from about 9.2 to about 9.8.

17. A method of treating an automotive surface, the method comprising:
applying a composition to an automotive surface, wherein the composition comprises:
an amino functional silicone emulsion;
a first alkaline agent; and,
a second alkaline agent.

18. The method of claim 17, wherein the automotive surface is selected from the group consisting of a tire, wheel, paint, hood, roof, trunk, an exterior part, an interior part, and combinations thereof.

19. The method of claim 17, wherein the automotive surface is a wheel.

20. The method of claim 17, wherein the composition is a fluid, and the liquid is applied by the means of an aerosol, a trigger sprayer, a sponge, and combinations thereof.
